(19) United States
(12) Patent Application Publication
(10) Pub. No.: US 2017/0038592 A1
(43) Pub. Date: Feb. 9, 2017

(54) IMAGE DISPLAY APPARATUS AND IMAGE DISPLAY SYSTEM

(71) Applicant: CANON KABUSHIKI KAISHA, Tokyo (JP)

(72) Inventor: Toshiyuki Sudo, Utsunomiya-shi (JP)

(73) Assignee: CANON KABUSHIKI KAISHA, Tokyo (JP)

(21) Appl. No.: 15/303,338

(22) PCT Filed: May 26, 2015
(86) PCT No.: PCT/JP2015/002654

§ 371 Date: Oct. 11, 2016

(30) Foreign Application Priority Data
Jun. 5, 2014 (JP) 2014-116408

(51) Int. Cl. G02B 27/01; G02B 27/00; G06F 3/01; G02B 3/00

(52) U.S. Cl. CPC G02B 27/0172; G02B 3/0056; G02B 27/0025; G06F 3/013; G02B 27/0176; G02B 2027/011; G02B 2027/0123; G02B 2027/014; G02B 2027/015; G02B 2027/0152

(57) ABSTRACT

An image display apparatus includes an image modulation unit including a plurality of pixels and capable of independently modulating a plurality of light beams emitted from the pixels, and a lens unit configured to convert the light beams emitted from the pixels into a plurality of collimated light beams that intersect with one another at points in a pupil of a viewer, the image modulation unit being configured to modulate the light beams so that the collimated light beams coincide with light beams incident on the points in the pupil from virtual pixels provided on a virtual image plane.

### TECHNICAL FIELD

The present invention relates to an image display apparatus used at a position close to the eyes of a viewer while being mounted on, for example, the head of the viewer.

### BACKGROUND ART

A conventional apparatus projects, as a virtual image in an enlarged size through an ocular optical system, an image displayed on an image display apparatus so that the image is observable as a wide view angle image. For example, an apparatus that is mounted on the head of a viewer and allows observation of a virtual image is called a head-mounted display (HMD) and is popular as a small apparatus capable of displaying a wide view angle image. However, typically, such an apparatus needs an ocular optical system to obtain a high view angle image. Since such an ocular optical system, which is of high power with a large diameter and a short focal length, has a large thickness and requires a great number of lenses for aberration correction, the image display apparatus suffers increases in its size and weight.

PTL 1 discloses an image display apparatus capable of displaying a virtual image without using an ocular optical system.

### CITATION LIST

### Patent Literature

[PTL 1] Japanese Patent Laid-open No. 2007-3984

### SUMMARY OF INVENTION

### Technical Problem

The configuration disclosed in PTL 1 is unable to display a virtual image at a desired position. In addition, with the configuration of Patent Document 1, a desired resolution of the virtual image cannot be obtained, so that the virtual image looks degraded, and a double image is observed depending on the positions of the eyes of a viewer. Thus, the configuration of Patent Document 1 cannot appropriately display the virtual image.

The present invention provides a small image display apparatus and a small image display system that can appropriately display a virtual image without using an ocular optical system.

### Solution to Problem

An image display apparatus as one aspect of the present invention includes an image modulation unit including a plurality of pixels and capable of independently modulating a plurality of light beams emitted from the pixels, and a lens unit configured to convert the light beams emitted from the pixels into a plurality of collimated light beams that intersect with one another at points in a pupil of a viewer, the image modulation unit being configured to modulate the light beams so that the collimated light beams coincide with light beams incident on the points in the pupil from virtual pixels provided on a virtual image plane.

An image display system as another aspect of the present invention includes the image display apparatus, and an image information supply apparatus configured to supply image information to the image display apparatus.

Further features and aspects of the present invention will become apparent from the following description of exemplary embodiments with reference to the attached drawings.

### Advantageous Effects of Invention

The present invention provides a small image display apparatus and a small image display system that are capable of appropriately displaying a virtual image without using an ocular optical system.

### BRIEF DESCRIPTION OF DRAWINGS

FIG. 1 is an explanatory diagram of an image display apparatus that allows observation of a virtual image without using an ocular optical system according to a first embodiment of the present invention.

FIG. 2 is an explanatory diagram of a simulated light beam in the first embodiment.

FIG. 3 is an explanatory diagram of actual light beams emitted from the virtual image in the first embodiment.

FIG. 4 is a table listing a passing point of the simulated light beam in the first embodiment.

FIG. 5 is an explanatory diagram of a case in which an intersection-point plane A of collimated light beams does not coincide with a virtual image plane B in the first embodiment.

FIG. 6 is an explanatory diagram of a case in which a pixel pitch Δi of the virtual image does not coincide with an intersection-point interval Δc of the collimated light beams in the first embodiment.

FIG. 7 is a relational diagram of a pixel pitch Δd and a light beam focusing point pitch Δp in the first embodiment.

FIG. 8 is a relational diagram of the pixel pitch Δd and the light beam focusing point pitch Δp in the first embodiment.

FIG. 9 is a relational diagram of the position of the intersection-point plane A and the pixel pitch Δi of the virtual image in the first embodiment.

FIG. 10 is an explanatory diagram of a normal observation of the virtual image due to a main lobe in a second embodiment of the present invention.

FIG. 11 is an explanatory diagram of generation of a double image due to a sidelobe in the second embodiment.

FIG. 12 is a configuration diagram of an image display apparatus in the second embodiment.

FIG. 13 is a configuration diagram of the image display apparatus in the second embodiment.

FIG. 14 is an explanatory diagram of influence of optical aberration of a micro lens array in a third embodiment of the present invention.

FIG. 15 is an explanatory diagram of a beam determination method using an effective pupil region in the third embodiment.

FIG. 16 is a coordinate conversion table in the third embodiment.

FIG. 17 is an exemplary spot diagram in the third embodiment.

FIG. 18 is an explanatory diagram of a case in which the virtual image has a high image height in a fourth embodiment of the present invention.

FIG. 19 is an explanatory diagram of a case in which the virtual image has a high image height in the fourth embodiment.

FIG. 20 is an explanatory diagram of an image display apparatus in the fourth embodiment.

FIG. 21 is an explanatory diagram of a beam effective condition in the fourth embodiment.

FIG. 22 is an explanatory diagram of an abnormal observation in the fourth embodiment.

FIG. 23 is an explanatory diagram of a normal observation in the fourth embodiment.

FIG. 24 is a configuration diagram of an image display apparatus in a fifth embodiment of the present invention.

FIG. 25 is a configuration diagram of the image display apparatus in the fifth embodiment.

### DESCRIPTION OF EMBODIMENTS

Exemplary embodiments of the present invention will be described below with reference to the accompanied drawings.

### First Embodiment

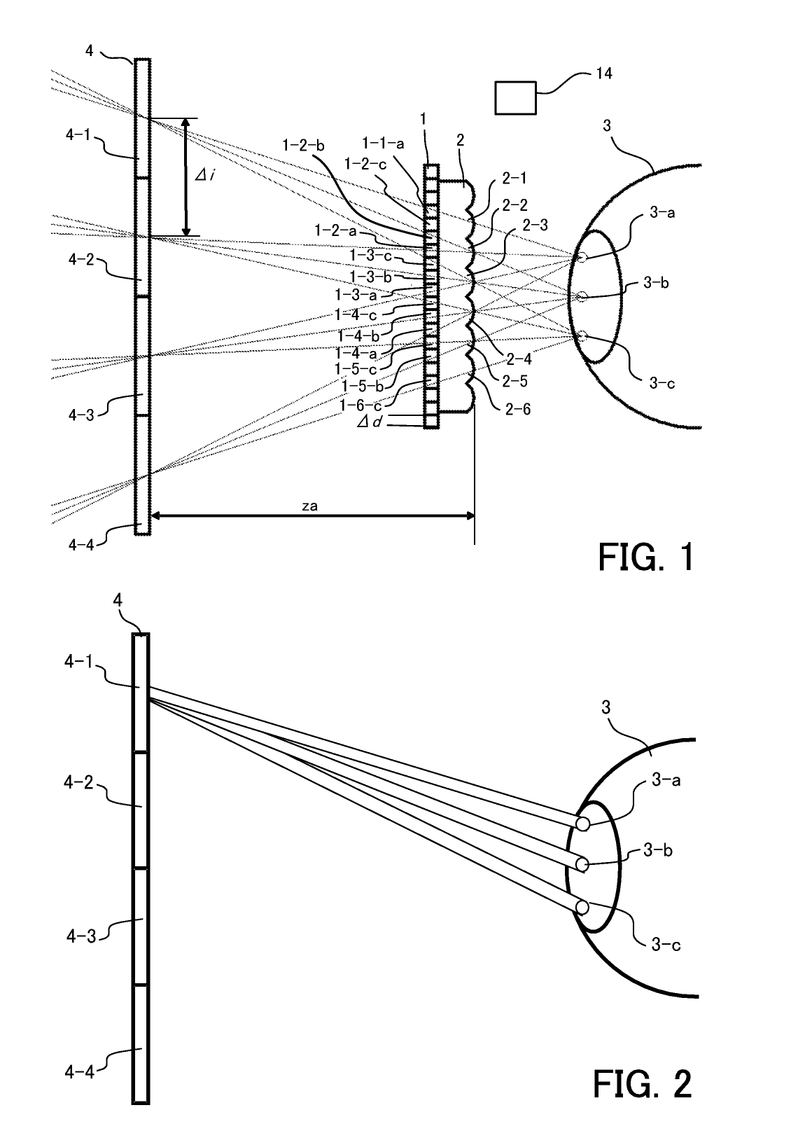

First, referring to FIG. 1, the mechanism of an image display apparatus capable of displaying a virtual image without using an ocular optical system will be described. FIG. 1 is an explanatory diagram of the image display apparatus.

In FIG. 1, reference numeral 1 denotes a display (two-dimensional image display element). The display 1 includes a plurality of pixels, and is an image modulation element (image modulation unit) capable of independently modulating light beams emitted from the pixels. The display 1 may be a light-emitting display unit such as a liquid crystal display and an organic EL display. Reference numeral 2 denotes a micro lens array (MLA). The MLA 2 is a lens unit that converts a plurality of light beams (at least part of all light beams) emitted from the pixels of the display 1 into a plurality of collimated light beams (parallel light beams or single-directional beams) that intersect with one another at points (light beam focusing points) in a pupil of a viewer. Reference numeral 3 denotes an eye (pupil) of the viewer. The display 1 is disposed at a position away from element lenses of the MLA 2 by a focal length fm. The MLA 2 converts the light beams emitted from the pixels on the display 1 into collimated light beams and emits the collimated light beams from the individual element lenses of the MLA 2. In the figures, unless otherwise stated, a “light line” represents an optical axis of each light beam. The present embodiment may provide an image display system that includes the image display apparatus (the display 1 and the MLA 2) and an image information supply apparatus 14 (computer) configured to supply image information to the image display apparatus.

Each three pixel of the display 1 correspond to one element lens of the MLA 2. A light beam from each pixel of the display 1 is emitted in three predetermined directions. For example, three pixels 1-2-a, 1-2-b, and 1-2-c of the display 1 correspond to an element lens 2-2 of the MLA 2. Light beams from the pixels 1-2-a, 1-2-b, and 1-2-c are adjusted (designed) to be incident on respective points (light beam focusing points) 3-a, 3-b, and 3-c in the eye 3 (pupil) of the viewer. This relation holds for all other element lenses as well. For example, three pixels 1-3-a, 1-3-b, and 1-3-c correspond to an element lens 2-3. Light beams from the pixels 1-3-a, 1-3-b, and 1-3-c are adjusted (designed) to be incident on respective points 3-a, 3-b, and 3-c in the eye 3 (pupil) of the viewer.

Next, the mechanism of the image display apparatus illustrated in FIG. 1 for displaying a virtual image without using an ocular optical system will be described. A method of displaying, for example, a virtual image 4 in FIG. 1 will be described. The virtual image 4 (virtual light source array) is formed by pixels (virtual pixels) 4-1, 4-2, 4-3, and 4-4. For the viewer to recognize, for example, the pixel 4-1, a light beam (simulated light beam) simulating image display light emitted from the pixel 4-1 needs to be incident on the pupil of the viewer. This simulated light beam corresponds to three light beams that are emitted from pixels 1-1-a, 1-2-b, and 1-3-c, converted through element lenses 2-1, 2-2, and 2-3 into collimated light beams, and pass through the respective points 3-a, 3-b, and 3-c in the eye 3 (pupil) in FIG. 1.

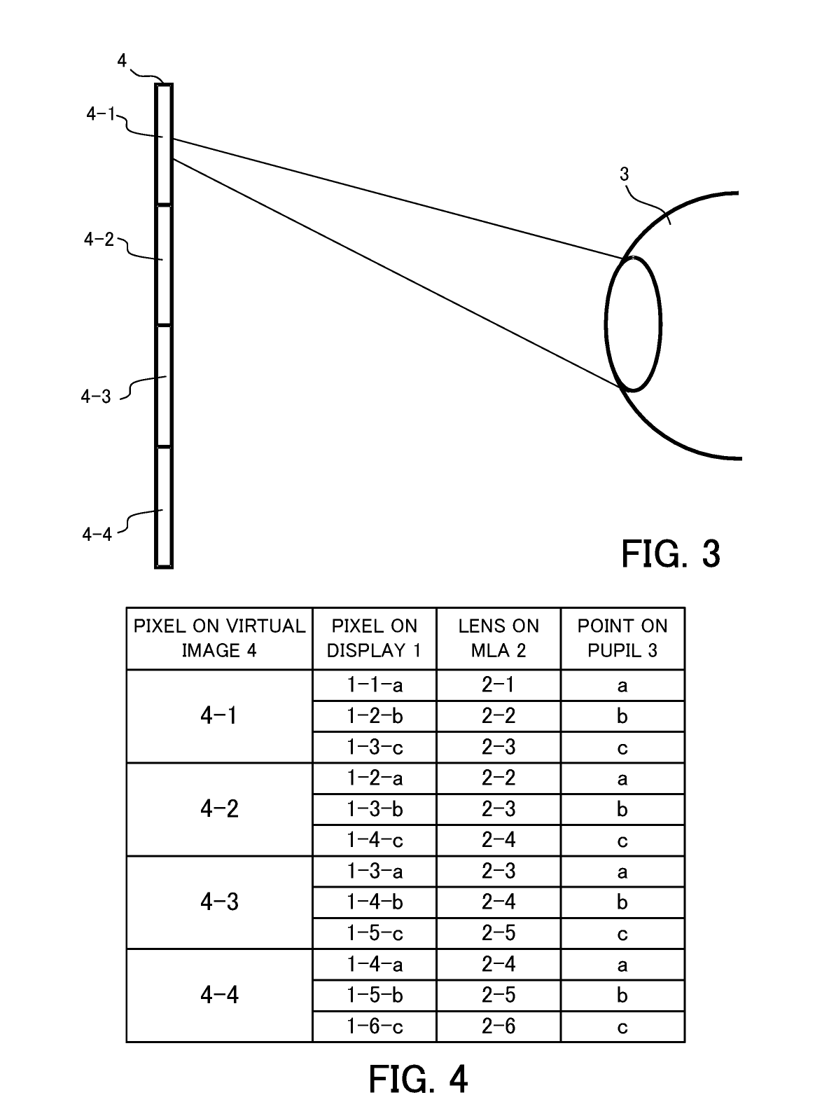

FIG. 2 is an explanatory diagram of a simulated light beam and illustrates that three simulated light beams from the pixel 4-1 of the virtual image 4 are incident on the points 3-a, 3-b, and 3-c in the eye 3 (pupil). FIG. 3 is an explanatory diagram of an actual light beam emitted from the virtual image 4 and illustrates that an image display light beam when the pixel 4-1 of the virtual image 4 actually emits image display light is incident on the eye 3 (pupil) of the viewer.

As understood from FIGS. 2 and 3, the simulated light beam and the actual light beam are similar in terms of the directionalities of the light beams. Thus, the light beams in FIGS. 2 and 3 are both recognized by the viewer as light emitted from the pixel 4-1. In the present embodiment, when the pixels 1-1-a, 1-2-b, and 1-3-c of the display 1 are set to have identical light intensities and colors, the viewer recognizes light beams emitted from these pixels as a light beam emitted from the single pixel 4-1. Similarly, when light beams intersecting at a central position of each pixel are set to have identical light intensities and colors, the light beams are recognized by the viewer as the pixels 4-2, 4-3, and 4-4 on the virtual image 4.

FIG. 4 is a table listing a condition on a point through which a simulated light beam is required to pass to allow the viewer to recognize the virtual image 4. FIG. 4 lists relations among the pixels 4-1 to 4-4 on the virtual image 4, the pixels 1-1-a to 1-6-c on the display 1, and points a to con the eye 3 (pupil), as points through which simulated light beams pass. A light beam from one pixel on the virtual image 4 is simulated (a simulated light beam is obtained) by collectively observing a plurality of light beams that are emitted from the MLA 2 and incident at a plurality of different points on the eye 3 (pupil). To obtain such a simulated light beam, the pixels 1-1-a, 1-1-b, and 1-1-c of the display 1 need to display respective parallax images for the points 3-a, 3-b, and 3-c in the eye 3 (pupil) of the viewer.

FIG. 1 is a plan view illustrating an optical arrangement in a horizontal section. The pixels on the display 1, the element lenses of the MLA 2, and positions (light beam passing points) on the eye 3 (pupil) are two-dimensionally arranged (arranged in two-dimensional matrices). Thus, the same arrangement holds in a vertical plane as well, and the virtual image 4 formed by pixels in a two-dimensional matrix can be obtained.

Such a configuration allows the viewer to observe a virtual image (virtual image at a position further distant from a near point of adjustment of eyes) without using an ocular optical system. This can prevent increase in the size and weight of an image display apparatus such as a HMD. The “near point of adjustment of eyes” means a nearest point at which the viewer can distinctly see an object through adjustment of eyes, and is also referred to as the distance of distinct vision. According to a literature (Takashi Utsumi, “Handbook of Ophthalmologic Examination Techniques”, third edition, p. 62, 1999), the near point of adjustment of eyes is 7 cm (14D) at the age of 10, 10 cm (10D) at the age of 20, and 14.3 cm (7D) at the age of 30 (D denotes diopter representing a diopter scale), changing with age. Disposing the MLA 2 (element lenses) that performs virtual image display according to the present embodiment at a shorter distance than, for example, 6.7 cm (15D), prevents the eyes from focusing on the MLA 2 and facilitates focusing on a displayed virtual image.

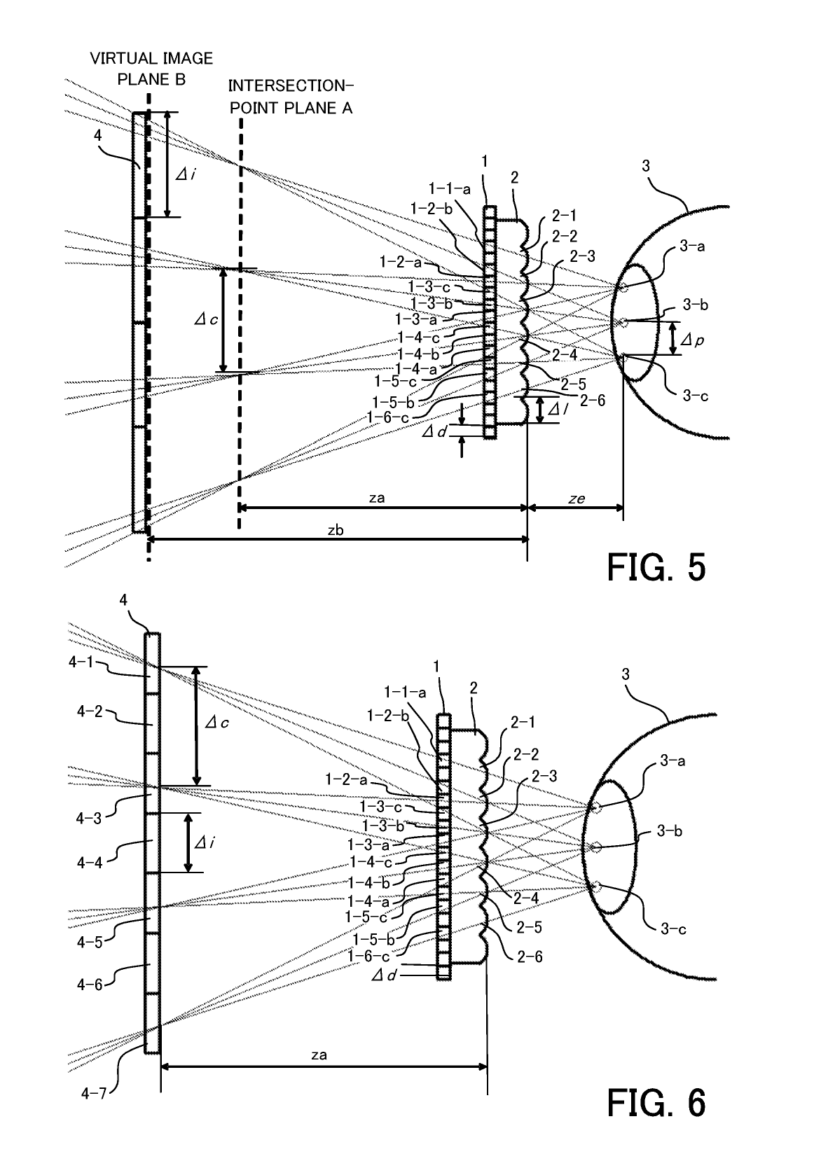

FIG. 1 illustrates the case in which the positions of intersection points of a plurality of collimated light beams coincide with the positions of the centers of the pixels (for example, the center of the pixel 4-1) on the expected virtual image 4. However, the positions of the intersection points of the collimated light beams (the position of one of a plurality of planes including intersection points at which oppositely extended lines to central traveling directions of the collimated light beams intersect with each other) do not necessarily coincide with the positions of the centers of the pixels on the virtual image 4. In other words, as illustrated in FIG. 5, the positions of the intersection points (intersection-point plane A) of the collimated light beams may not coincide with the positions of the centers (virtual image plane B) of the pixels on the expected virtual image 4. In FIG. 5, a distance zb from a lens principal plane of the MLA 2 to the virtual image plane B is longer than a distance za from the lens principal plane of the MLA 2 to the intersection-point plane A. In the present specification and figures, all distances are in “optical distances”. In other words, the distances are all in numerical values converted through “optical distance=actual distance/optical refractive index”. In such a case illustrated in FIG. 5, since simulated light beams simulate light beams emitted from the intersection-point plane A, the viewer cannot recognize, for example, information of the pixel 4-1.

In the present embodiment, the image display apparatus is configured such that the distances za and zb substantially coincide with each other. The wording “substantially coincide” means not only that the distances za and zb precisely coincide with each other, but also that the distances za and zb essentially coincide with each other. A specific range of the “substantially coincide” will be described later.

When the intersection-point plane A and the virtual image plane B substantially coincides with each other, but a pixel pitch Δi of the virtual image 4 is not equal to (does not substantially coincide with) an interval Δc of intersection points of a plurality of collimated light beams, a virtual image having a desired resolution cannot be observed. For example, description is made of a case in which the pixel pitch Δi of the virtual image 4 is less than half the interval Δc of the intersection points of the collimated light beams as illustrated in FIG. 6. In this case, pixels recognizable by the viewer among the pixels 4-1 to 4-7 of the virtual image 4 illustrated in FIG. 6 are only four points of the pixel 4-1, 4-3, 4-5, and 4-7, and the virtual image has a degraded resolution less than half a resolution obtainable with all pixels of the virtual image 4. When a ratio of the pixel pitch Δi of the virtual image 4 and the interval Δc of the intersection points of the collimated light beams is not an integer, sampling at the interval Δc from the pixels with the pixel pitch Δi generates wavy periodic image degradation noise, resulting in a more significant image degradation.

In the present embodiment, the pixel pitch Δi of the virtual image 4 and the interval Δc of the intersection points of the collimated light beams are set to be equal to each other (substantially coincide with each other), or the ratio of Δi/Δc or Δi/Δc is set to be an integer. A specific method will be described later. This setting of the pixel pitch Δi of the virtual image 4 and the interval Δc of the intersection points of the collimated light beams optimizes a previously prepared resolution of the virtual image 4, and thus can minimize deterioration of the resolution of the virtual image 4 observable by the viewer.

In order to achieve the image display apparatus having an optical property illustrated in FIG. 1, certain relations need to be held between various optical parameters of the display 1, the MLA 2, and the eye 3 (pupil). As described above, the position and resolution of the virtual image 4 are desired to be previously obtained based on the optical parameters to optimize the position and resolution. In the present embodiment, these relations are previously obtained so that the image display apparatus is configured under an effective condition.

The various optical parameters include: ze representing the distance between the lens principal plane of the MLA 2 and the light beam focusing points (points 3-a to 3-c) of the eye 3 (pupil); zm representing the optical distance between the lens principal plane of the MLA 2 and the pixels on the display 1; za representing the distance between the lens principal plane of the MLA 2 and an intersection point (the intersection-point plane A) of collimated light beams (three straight lines); Δp representing the distance (light beam focusing point pitch) between neighboring light beam focusing points (points 3-a to 3-c) in the eye 3 (pupil); Δl representing the pitch (lens pitch) between the element lens of the MLA 2; and Δd representing the pixel pitch of the display 1.

According to similarity of two triangles illustrated with bold lines in FIG. 7, a relation represented by Expression (1) below is preferably held between the pixel pitch Δd of the display 1 and the distance (light beam focusing point pitch Δp) between neighboring light beam focusing points in the eye 3 (pupil).

$$\frac{ze}{Δ p} = \frac{zm}{Δ d} \qquad ( 1 )$$

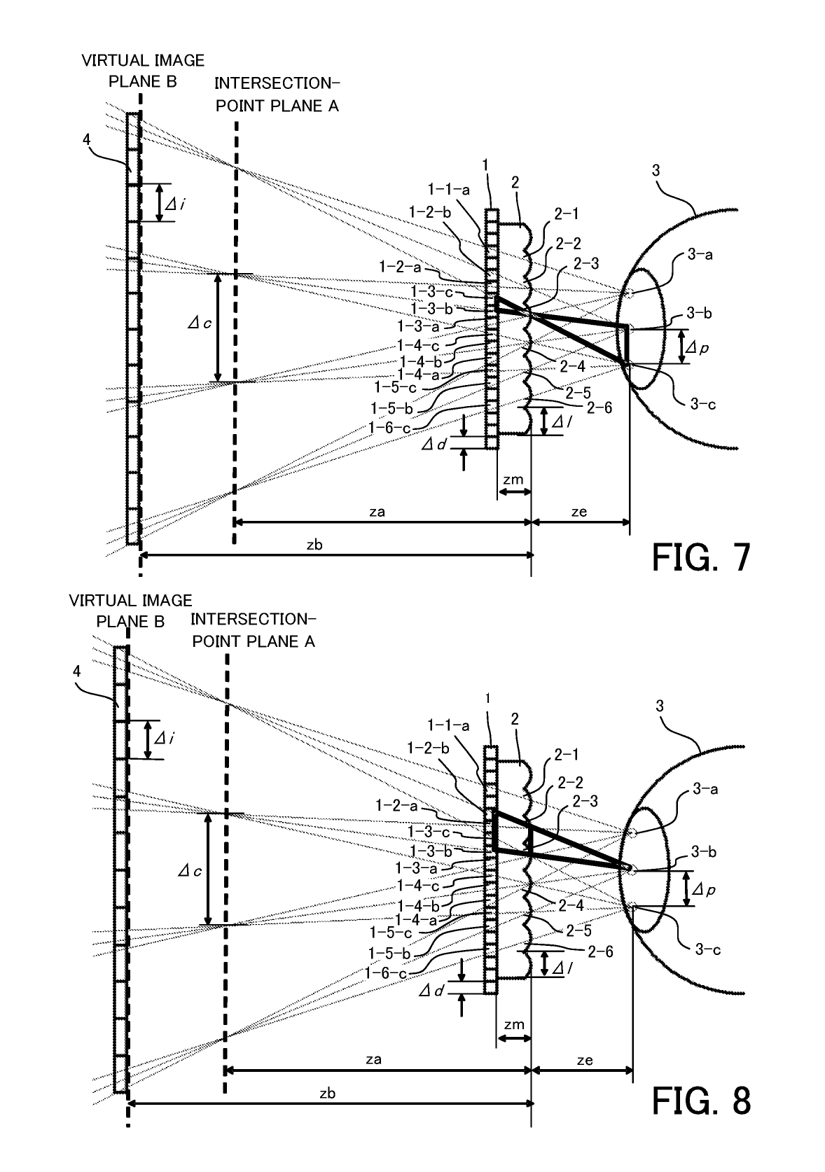

In addition, according to similarity of two triangles illustrated with bold lines in FIG. 8, a relation represented by Expression (2) below is preferably held between the lens pitch Δl of the MLA 2 and the pixel pitch Δd of the display 1.

$$\frac{zm + ze}{N Δ d} = \frac{ze}{Δ l} \qquad ( 2 )$$

In Expression (2), N represents the number of light beam focusing points formed in the eye 3 (pupil). This means that N pixels of the display 1 correspond to one element lens of the MLA 2.

Expressions (1) and (2) allow specific designing. Since a typical ocular optical system requires an eye relief of 20 mm approximately, ze is set to be 20 mm, for example. A human being has a pupil diameter of 3 to 7 mm approximately. Thus, in order to allow the viewer to constantly and simultaneously observe a plurality of simulated light beams, it is preferable to set the light beam focusing point pitch Δp to be 1 mm, and the number N of light beam focusing points to be three. Substituting these numerical values in Expressions (1) and (2) obtains Expressions (3) and (4) below.

$$\begin{matrix}zm = 20 Δ d & ( 3 ) \\ Δ l = \frac{3 Δ d}{Δ d + 1} & ( 4 )\end{matrix}$$

It is derived from Expressions (3) and (4) that zm and Δl need to be set to 200 μm and 2.98 mm, respectively, when the pixel pitch Δd of the display 1 is set to 10 μm.

Next, a relational expression of the position and resolution of the virtual image 4 is derived. As described above, the position of the virtual image 4 (virtual image plane B) needs to substantially coincide with the intersection-point plane A of collimated light beams. Thus, the position of the intersection-point plane A needs to be parameterized with other optical parameters.

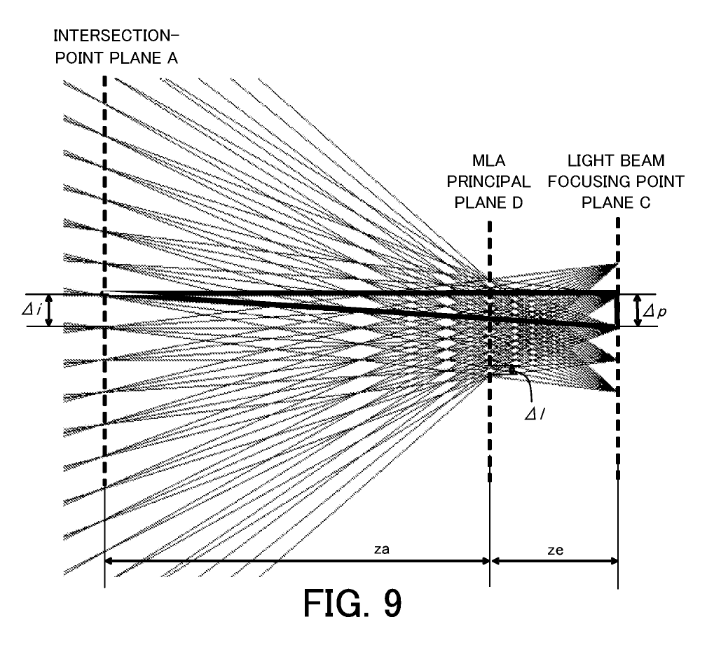

FIG. 9 is a relational diagram of the position of the intersection-point plane A of light beams and the pixel pitch Δi of the virtual image 4. To illustrate a plurality of light beams on the intersection-point plane A in detail, various other components are omitted in FIG. 9, and only light beams representing the optical axes of the light beams are illustrated. As illustrated with bold lines in FIG. 9, the light beams intersect with each other on extended lines of straight lines connecting light beam focusing points and the centers of the element lenses of the MLA 2. As understood from FIG. 9, typically, a light beam focusing point plane C and an MLA principal plane D are parallel to each other. Thus, the intersection-point plane A is parallel to the light beam focusing point plane C and the MLA principal plane D. Since light beam focusing points and the centers of the element lenses of the MLA 2 are discretely located, the intersection-point plane A is also discretely located. Two light beams forming an intersection point are apart from each other by an interval mΔl on the light beam focusing point plane C and by an interval nΔp on the MLA principal plane D where m an n are natural numbers, and thus the intersection-point plane A is uniquely determined by a combination of the natural numbers m and n. Then, the distance za from the MLA principal plane D to the intersection-point plane A is represented by Expression (5) below.

$$za = \frac{m Δ l}{m Δ l - n Δ p} ze \qquad ( 5 )$$

The interval Δc of intersection points of light beams on the intersection-point plane A is represented by Expression (6) below using the natural numbers m and n and the greatest common factor n of the natural numbers m and n.

$$Δ c = \frac{μΔ l Δ p}{m Δ l - n Δ p} \qquad ( 6 )$$

The greatest common factor μ in Expression (6) indicates that the intersection-point plane A is identical for (m, n)=(2, 1) and (m, n)=(4, 2), for example, and the interval Δc of intersection points of light beams is identical as well.

Next, how much the intersection-point plane A and the virtual image plane B need to coincide with each other to obtain an effective result, that is, the degree of “substantially coincide” described above, will be described. The interval Δc of intersection points of light beams on the intersection-point plane A illustrated in FIG. 5 is given by Expression (6). On the other hand, the pixel pitch Δi of the virtual image 4 on the expected virtual image plane B can be obtained by generalizing the relation of the triangles illustrated with the bold lines in FIG. 7 to include the virtual image plane B. Thus, the pixel pitch Δi of the virtual image 4 is given by Expression (7) below.

$$Δ c = \frac{μ Δ l Δ p}{m Δ l - n Δ p} \qquad ( 6 )$$

When the intersection-point plane A and the virtual image plane B are shifted from each other in a depth direction, the shift appears as a shift (pitch shift) between the interval Δc of intersection points of light beams and the pixel pitch Δi of the virtual image 4 viewed from the viewer. When the pitch shift is less than one pixel for each pixel of the virtual image 4, an image construction is not disrupted. Thus, a required condition is such that a cumulated value of the shift (pitch shift) between the interval Δc of intersection points of light beams and the pixel pitch Δi of the virtual image 4 is less than one pixel at an outmost part of the image. An image displayed as the virtual image is typically expressed in a two-dimensional pixel matrix. Thus, when N represents a larger one of the numbers of pixels in longitudinal and horizontal directions of the matrix, Conditional Expression (8) below is derived.

N·|Δi−Δd|<Δi (8)

Substituting Expressions (6) and (7) into Conditional Expression (8) and rewriting for zb yields Conditional Expression (9) below.

$$\frac{N}{N + 1} \cdot \frac{Δ c}{Δ p} ze < zb < \frac{N}{N - 1} \cdot \frac{Δ c}{Δ p} ze \qquad ( 9 )$$

Expression (9) is a conditional expression indicating how much the intersection-point plane A and the virtual image plane B need to coincide with each other, that is, indicating the degree of “substantially coincide”.

As described above, in the present embodiment, the image display apparatus is designed such that the position (distance zb) of the virtual image plane B substantially coincides with the position (distance za) of the intersection-point plane A of light beams calculated with Expression (5). In such a design, simulated light beams are converted into collimated light beams by the MLA 2 as described above, and incident on the eye 3 (pupil) of the viewer. The light beams are preferably adjusted to have a smallest diameter at the position (distance zb) of the virtual image plane B, which is useful in simulating light emitted from the position. Thus, the distance zm between the MLA principal plane and the display, and the focal length fm of the element lenses of the MLA 2 are preferably designed to satisfy Expression (10) below.

$$\frac{1}{zm} - \frac{1}{zb} = \frac{1}{{f}_{m}} \qquad ( 10 )$$

Degradation of an image to be displayed as the virtual image 4 can be reduced by previously setting the resolution (interval Δc of intersection points of light beams) of the image so as to satisfy Expression (6). In the present embodiment, it is most desirable to have the pixel pitch Δi of the virtual image 4 and the interval Δc of intersection points of light beams equal to each other, but the present invention is not limited thereto. For example, periodic image quality degradation noise generated at image sampling can be reduced by setting the ratio of Δi/Δc or Δi/Δc to be an integer.

### Second Embodiment

Next, an image display apparatus according to a second embodiment of the present invention will be described. The present embodiment illustrates an exemplary configuration to prevent observation of a double image generated depending on the positions of the eyes of the viewer. First, a cause of the generation of the double image will be described. The first embodiment describes the case in which three light beam focusing points (the points 3-a, 3-b, and 3-c) are formed by N pixels on the display 1 and one corresponding element lens of the MLA 2. However, any optical system including the MLA 2 has a problem of “generation of sidelobe”. The sidelobe is part of light from a particular pixel, which is incident not only on a target element lens but on a plurality of element lenses and has directionality in other than a desired direction. Main lobe is part of light from the particular pixel, which is incident only on the target element lens and has directionality in the desired direction.

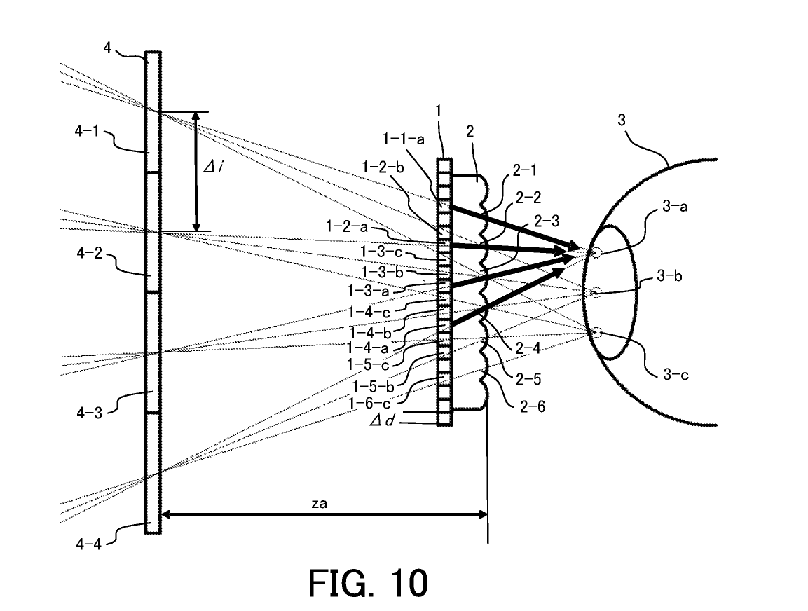

FIG. 10 is an explanatory diagram of normal observation of the virtual image due to the main lobe. As illustrated with bold lines in FIG. 10, light beams from the pixels 1-1-a, 1-2-a, 1-3-a, and 1-4-a are respectively incident on the element lenses 2-1, 2-2, 2-3, and 2-4 of the MLA 2, and have directionalities toward the light beam focusing point 3-a. However, when the light beam from each pixel is incident on an element lens other than the corresponding element lens, the sidelobe is generated.

FIG. 11 is an explanatory diagram of generation of a double image due to the sidelobe. As illustrated with bold dotted lines in FIG. 11, light beams from the pixels 1-1-a, 1-2-a, 1-3-a, and 1-4-a are respectively incident on the element lenses 2-2, 2-3, 2-4, and 2-5 of the MLA 2, which are located below the element lenses in the case illustrated in FIG. 10, and have directionalities toward a light beam focusing point 3-d. When the viewer puts the pupil at the light beam focusing point 3-d, the virtual image can be observed through light beams focusing thereon. However, the virtual image is a parallax image that is supposed to be observed at the light beam focusing point 3-a and should not be observed at the light beam focusing point 3-d. In addition, as illustrated in FIG. 11, a direction in which the virtual image is observed is displayed being shifted upward in the figure from a position at which the virtual image 4 should be displayed. When the light beam from each pixel is diffusive, the case illustrated in FIG. 10 and the case illustrated in FIG. 11 can be simultaneously generated. This displays an abnormal virtual image due to the sidelobe being superimposed on a normal virtual image due to the main lobe. For example, when the pupil of the viewer is place to have thereon three light beam focusing points 3-b, 3-c, and 3-d in FIG. 11 included, the viewer recognizes a double image of the normal virtual image and the abnormal virtual image.

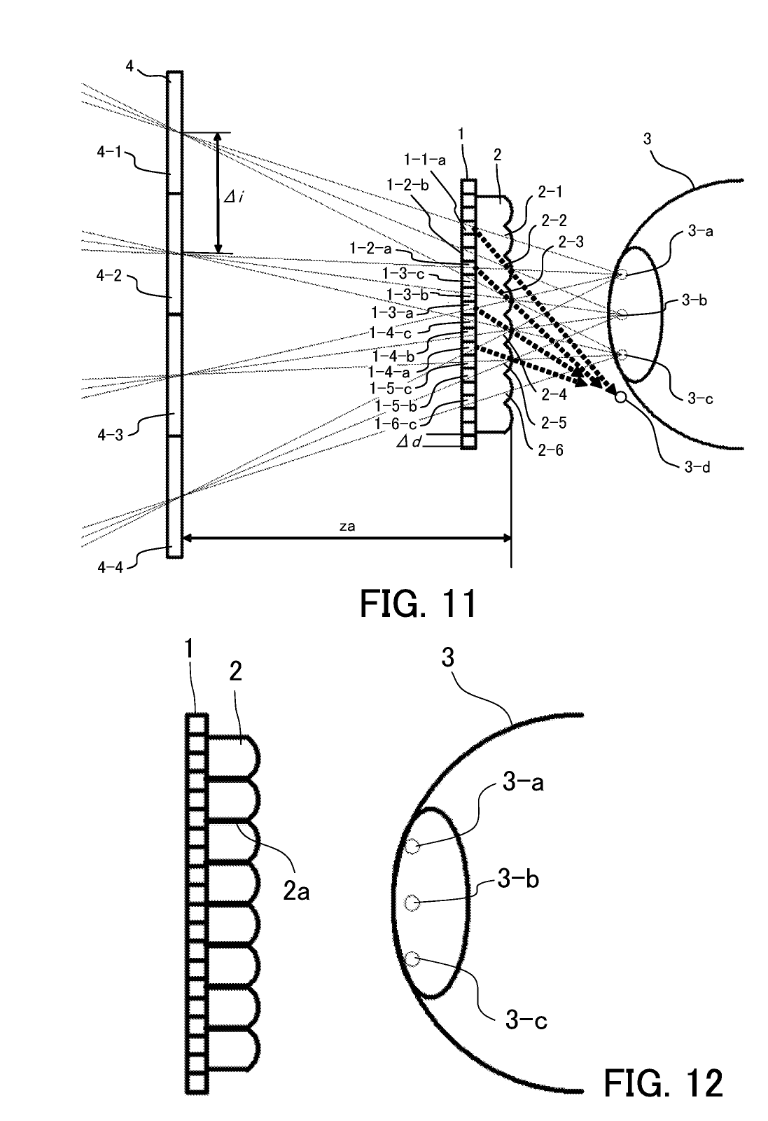

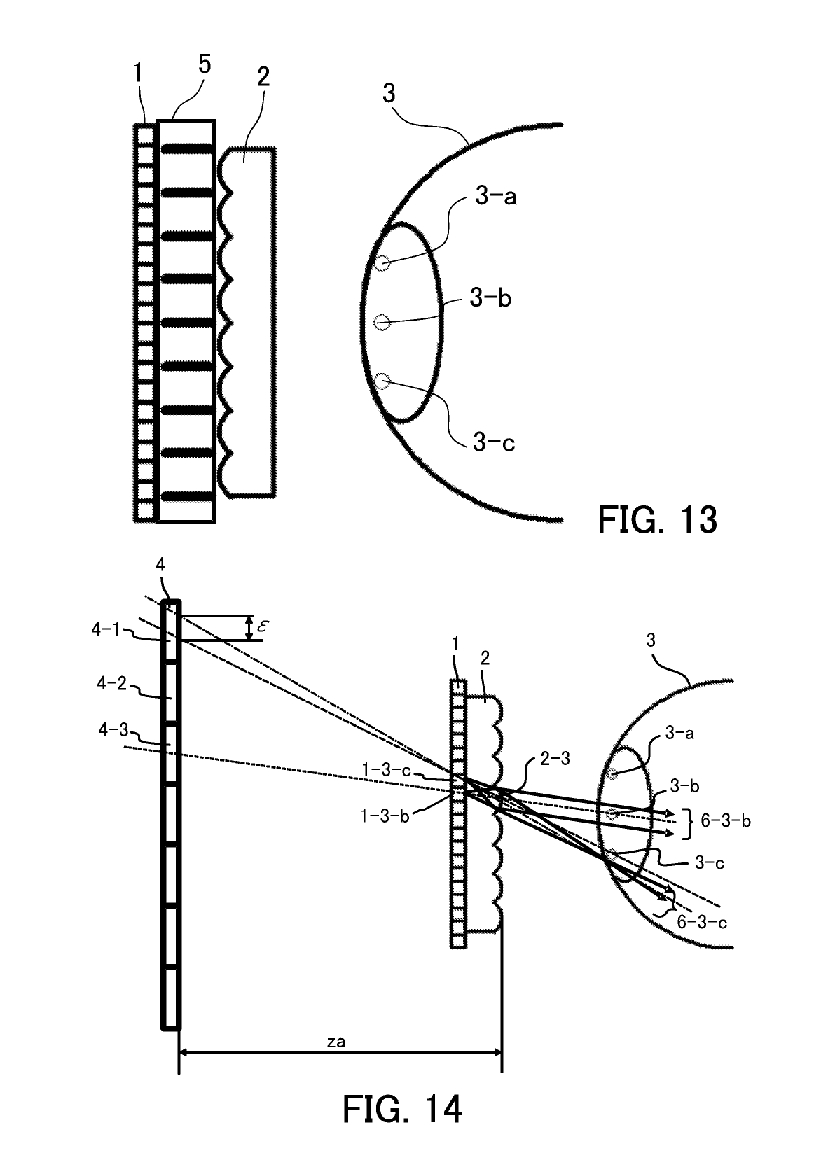

The image display apparatus in the present embodiment is configured such that the generation of the sidelobe is prevented or reduced as illustrated in FIG. 12 or 13. FIG. 12 is a configuration diagram of the image display apparatus in the present embodiment, illustrating an exemplary configuration of the MLA 2 for reducing the generation of the sidelobe. A partition 2a (light shielding member) that shields light is provided at the boundary of each element lens of the MLA 2. This configuration can be achieved by, for example, a method of manufacturing each element lens whose side surfaces thereof are applied with light-shielding paint, and then arranging the element lenses in the MLA 2 to be bonded together.

A exemplary configuration for reducing the sidelobe using the MLA 2 of a conventional configuration is illustrated in FIG. 13. The MLA 2 is disposed oppositely when viewed from the viewer, and a partition component 5 (light shielding member) is inserted between the MLA 2 and the display 1. A black part of the partition component 5 represents a light-shielding member, and a white part thereof represents a transparent member or air. The MLA 2, which is disposed oppositely, has the optical principal plane at substantially the same position as that in the case illustrated in FIG. 12, and has the same optical functionality. However, since the MLA has the light-shielding functionality and the lens functionality separately, components are more easily supplied for the configuration illustrated in FIG. 13 than for the configuration illustrated in FIG. 12. For example, the partition component 5 may be manufactured by a metal mask technique for providing a fine pattern on a thick metal, and a light shaping technique for precisely shaping a three-dimensional object from light-curing resin by laser beam scanning. Since the MLA 2 in the first embodiment may be used, the configuration illustrated in FIG. 13 is more easily achieved.

### Third Embodiment

Next, an image display apparatus according to a third embodiment of the present invention will be described. The present embodiment illustrates an exemplary configuration to prevent a positional shift of the virtual image due to aberration of the MLA 2. First, a case of generation of the shift will be described.

The first and second embodiments each obtains a correspondence relation between a pixel on the display 1 and a pixel on the virtual image 4 based on a geometric relation of a primary light beam without taking optical aberration of the MLA 2 into account. However, in reality, the optical aberration of the MLA 2 may have such an influence that a shift is generated in the imaging position of the virtual image 4.

FIG. 14 is an explanatory diagram of the influence of the optical aberration of the MLA 2. Description will be focused on the pixels 1-3-b and 1-3-c on the display 1 and the element lens 2-3 of the MLA 2. Divergent light emitted from the pixel 1-3-b is converted into a beam 6-3-b by the element lens 2-3. The pixel 1-3-b, which is near the optical axis of the element lens 2-3, is unlikely to generate aberration. Thus, the beam 6-3-b is substantially parallel light as geometrically designed, and passes through the light beam focusing point 3-b in the eye 3 (pupil) of the viewer. In this case, the viewer observes parallel light as if emitted in a direction (direction toward the pixel 4-3 on the virtual image 4) represented by a short broken line in FIG. 14.

On the other hand, divergent light emitted from the pixel 1-3-c is converted into a beam 6-3-c by the element lens 2-3. The pixel 1-3-b, which is away from the optical axis of the element lens 2-3, is likely to generate aberration. Thus, the beam 6-3-c may become convergent light or divergent light, or the beam may have a central position at the position of the eye 3 (pupil) of the viewer, which is shifted from the light beam focusing point 3-b as geometrically designed. In this case, the viewer observes a beam (parallel light) as if emitted in a direction represented by dashed line in FIG. 14, and does not observe the beam as if emitted in a direction (direction toward the pixel 4-1 on the virtual image 4) represented by a long broken line in FIG. 14 as originally designed. Thus, a difference ε on the virtual image 4 in FIG. 14 is generated between a direction observed by the viewer and a designed direction.

When an image is displayed on the display 1 through the same image data generation as in the first and second embodiments with such an influence due to aberration being present, the virtual image 4 is not imaged at desired direction and position, and a field curvature, distortion, or blurring may be generated.

To solve this problem, in the present embodiment, a correspondence relation between pixels on the display 1 and pixels on the virtual image 4 is calculated by a rigorous light beam trace with the optical aberration of the MLA 2 taken into account.

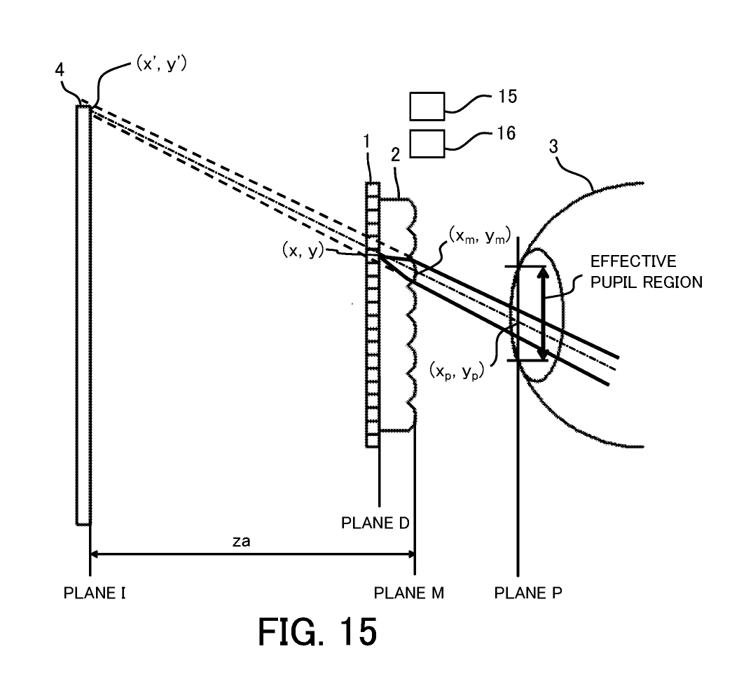

FIG. 15 is an explanatory diagram of a beam determination method using an effective pupil region. In FIG. 15, a plane D is a pixel surface of the display 1, and luminance is set at a point (x, y) on the pixel surface. Light emitted from the point (x, y) may be incident on a plurality of element lenses of the MLA 2, but is assumed to pass through an element lens at a center coordinates (xm, ym) in this description. Light emitted from the element lens is formed in a beam and incident on a plane P at the position of the pupil of the viewer. The coordinates of the center of the beam on the plane P is denoted by (xp, yp). It is determined based on the coordinates (xp, yp) of the center of the beam whether the beam is effective in generating the virtual image. Such a determination is performed by a control unit (not illustrated) of the image display apparatus. In the present embodiment, the plane P at which the pupil of the viewer is expected to be disposed is set, the effective pupil region is defined as a region having a certain radius from the center of the pupil on the plane P. In other words, the effective pupil region is set as a region inside a circle centering about the center of the pupil on a surface identical to that of the pupil of the viewer. Thus, the determination (determination of being effective or ineffective) of the beam is performed based on whether the coordinates (xp, yp) of the center of the beam is in the effective pupil region.

For example, when a condition represented by Expression (11) below is satisfied, where the radius of the effective pupil region is represented by R, and the center of the pupil is assumed to be disposed at a point (0, 0) in the plane P, the beam is determined to be effective.

xₚ²+yₚ²<R² (11)

A correspondence relation between the point (x, y) on the plane D and the center coordinates (xm, ym) of the element lens is not limited to a particular relation. Thus, the determination of the beam is preferably performed for the center coordinates (xm, ym) of each of a plurality of element lenses.

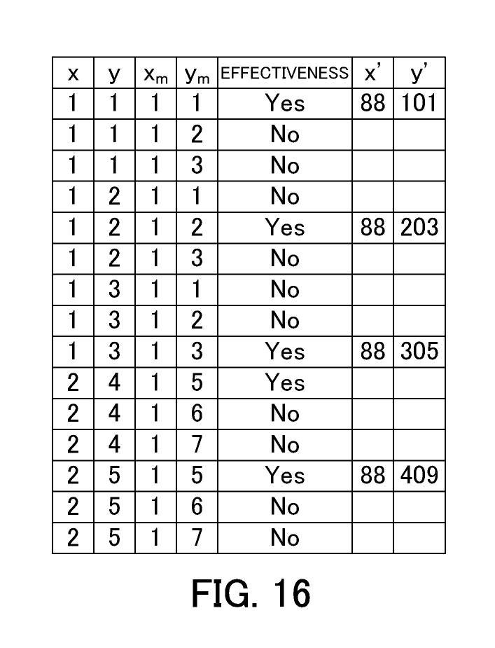

When the beam is determined to be effective in the determination, a light beam locus of the beam is traced back to a virtual image plane (plane I) to calculate the coordinates of the center of the beam (x′, y′) on the plane I. In this manner, a correspondence relation between the pixel (x, y) and the virtual image point (x′, y′) can be acquired accurately based on a rigorous light beam trace. The data of this relation may be stored as, for example, a correspondence table as illustrated in FIG. 16, and used as a coordinate conversion table for generating the virtual image.

For example, when an image having an image luminance distribution I′ (x′, y′) is to be displayed as the virtual image 4, a conversion from (x′, y′) to (x, y) is performed based on a coordinate conversion table illustrated in FIG. 16. This allows an image luminance distribution I (x, y) on the display 1 to be acquired, and a desired virtual image to be observed when displayed on the display 1. However, as described above, in reality, a plurality of element lense passing beams may be determined to be effective for one the point (x, y). Thus, a selection rule is preferably set to achieve an one-to-one coordinate relation. For example, when a plurality of element lense passing beams are determined to be effective for one point (x, y), one rule can be such that one of the beams whose center coordinates (xp, yp) on the plane P is closest to the center of the pupil coordinates (0, 0) is selected. Such a rule allows the conversion from (x′, y′) to (x, y) to be uniquely determined.

As described above, when the virtual image is actually displayed, the conversion from (x′, y′) to (x, y) is performed. However, the light beam trace method described above involves data acquisition in an opposite order from (x, y) to (x′, y′), which makes it difficult to produce a conversion table. To solve this difficulty, data acquisition through a light beam trace in order from (x′, y′) to (x, y) is effective. In this method, the light beam trace starts at a pixel (x′, y′) on the virtual image. First, the control unit 15 illustrated in FIG. 15 determines whether a straight line connecting the pixel (x′, y′) and center coordinates (xm, ym) of the element lens passes through the effective pupil region. This determination is performed for a plurality of element lenses. Only when determining that the straight line passes through the effective pupil region, the control unit 15 performs such a reverse light beam trace that the beam travels back to be incident on the element lens 2 and imaged on the display 1. In other words, the control unit 15 performs the reverse light beam trace only for a light beam passing through a pixel (light source of the virtual light source array) on the virtual image 4, the MLA 2, and the effective pupil region. Then, the control unit 15 provides a luminance for emitting light to a pixel disposed at the position of the intersection point of the light beam and the display 1. An imaging position (x, y) on the plane D of the display 1 is acquired as coordinates corresponding to a pixel (x′, y′) on the virtual image, and a coordinate conversion table (data conversion table) of (x′, y′) to (x, y) can be easily obtained. This result of the reverse light beam trace may be previously stored as the data conversion table in a storage unit 16. Then, the control unit 15 refers to the data conversion table when causing the display 1 to modulate a plurality of light beams.

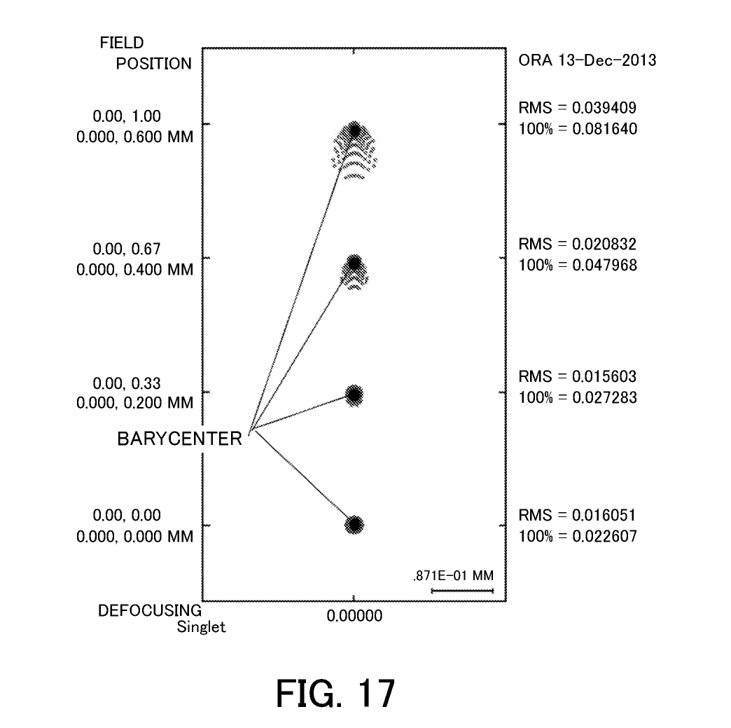

The position of the “barycenter” of a beam spot output from a light beam tracing tool is preferably used as a beam center when the center coordinates (xp, yp) of the beam and the pixel (x′, y′) on the virtual image are calculated. FIG. 17 is an exemplary spot diagram, and is an explanatory diagram of the barycenter of the beam spot. The beam spot is a drawing of reaching points, on an image plane, of light beams passing through the centers of the divided pupils obtained by dividing the pupil of the beam. The barycenter is defined as a point for achieving balancing support on the plane P when these reaching points are assumed to have equal weights. The barycenter intrinsically has a correlation with a density distribution of light beams, is likely to exist in a high region having a high light beam density. Thus, the barycenter is a point at which a highest beam intensity is observed by the viewer, can be regarded as an effective center of the beam.

### Fourth Embodiment

Next, an image display apparatus according to a fourth embodiment of the present invention will be described. The present embodiment illustrates an exemplary configuration for solving the problem that the image height of a virtual image is high enough to cover a peripheral part of the virtual image and prevent observation thereof.

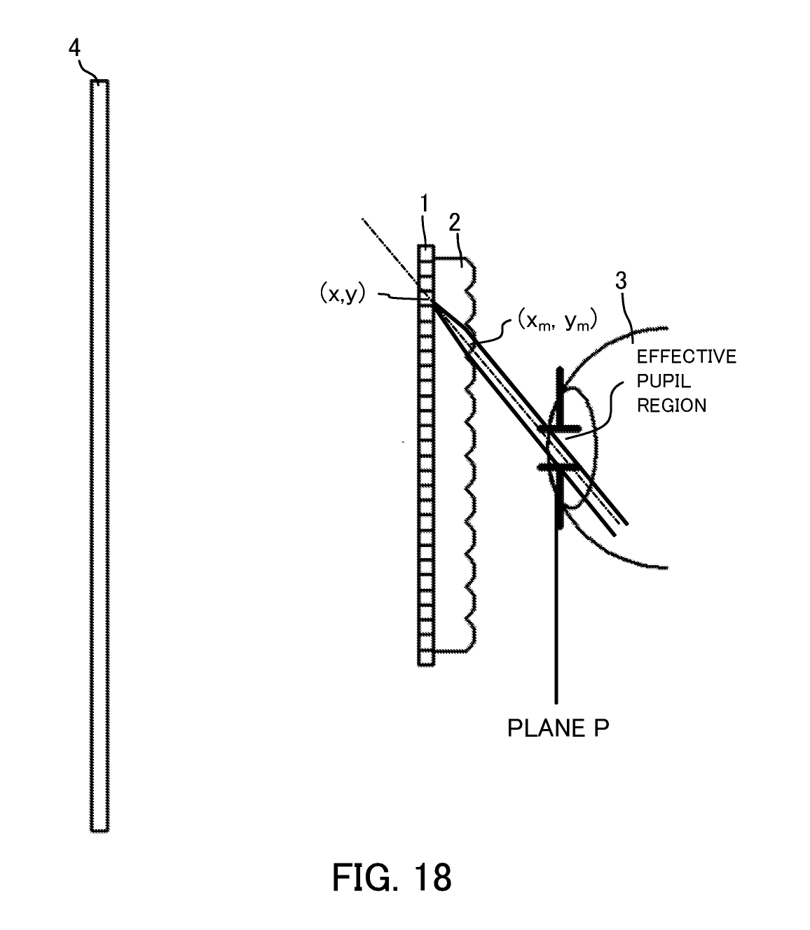

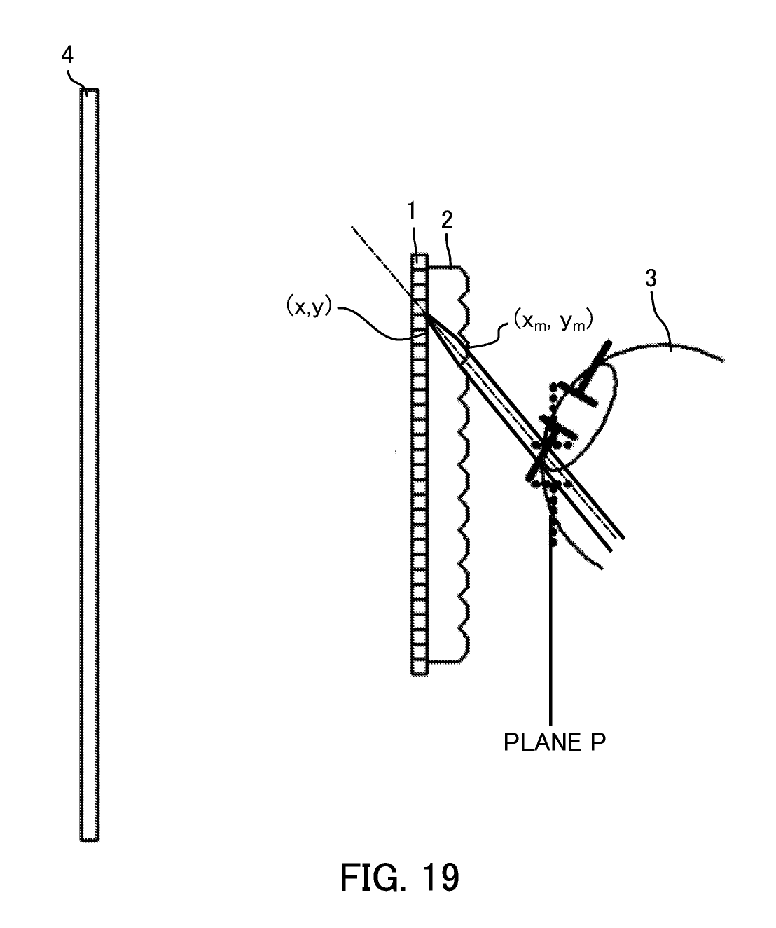

First, referring to FIGS. 18 and 19, the problem will be described. FIGS. 18 and 19 are each an explanatory diagram when the image height of the virtual image is high, and each illustrate a method of providing the effective pupil region on the plane P at which the pupil of the viewer is disposed, and generating the virtual image by using beams passing through the effective pupil region, as in the third embodiment. FIG. 18 illustrates a case in which light emitted from an element lens at a position corresponding to an extremely high view angle is incident on the effective pupil region. When the viewer observes a central part of the virtual image, the pupil of the viewer and the effective pupil region substantially coincide with each other. Thus, a virtual image observed by the viewer has no vignetting generated, so that the whole of the virtual image can be observed.

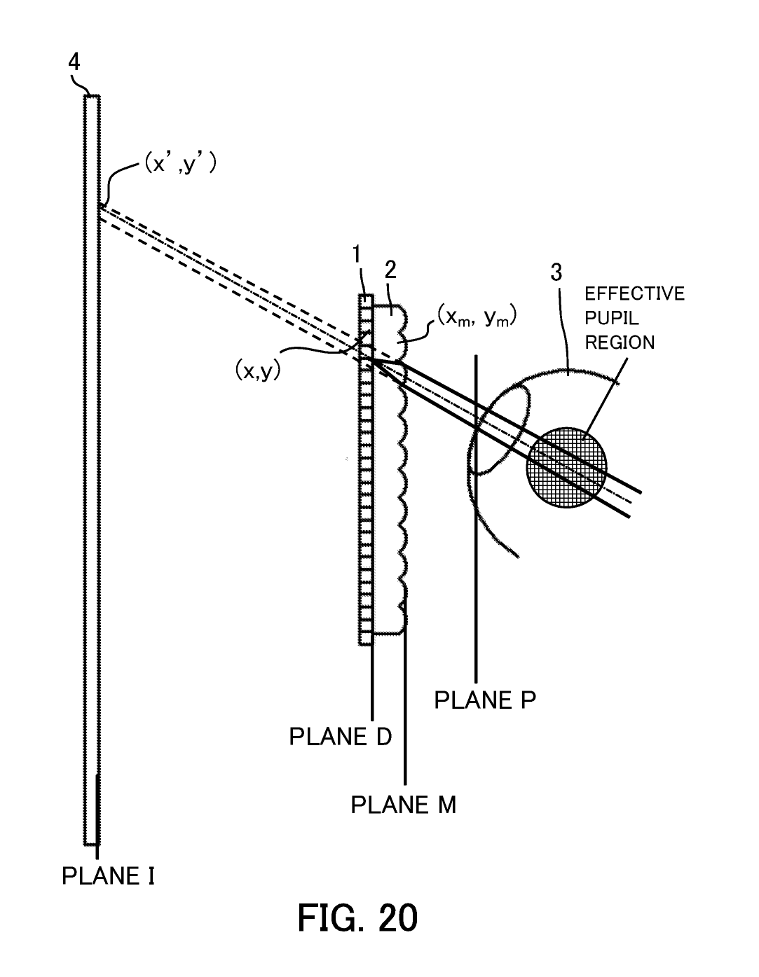

On the other hand, when the eye 3 (eyeball) of the viewer rotates to observe the peripheral part of the virtual image as illustrated in FIG. 19, the pupil of the viewer moves to a position different from that of and the effective pupil region (plane P). Thus, image display light is not incident on the pupil, and vignetting is generated in a virtual image observed by the viewer. In the present embodiment, as illustrated in FIG. 20, the “effective pupil region” is defined to be, not inside a circle on the plane P, but inside a three-dimensional sphere centering about the eye 3 (eyeball) of the viewer. In other words, the effective pupil region is set as a region inside a sphere centering about a rotation center of the eyeball of the viewer.

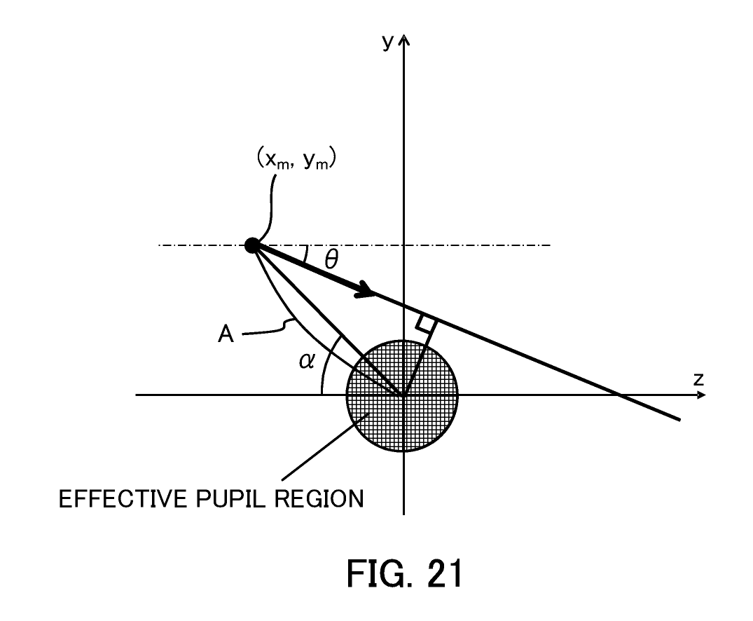

In such a configuration, the control unit according to the present embodiment performs the determination of an effective beam and the coordinate conversion from (x′, y′) to (x, y). In other words, the control unit performs the beam effectiveness determination based on whether a beam emitted from an element lens at the center coordinates (xm, ym) passes through the effective pupil region. For example, when the radius of the effective pupil region is represented by R, and the center of the pupil is assumed to be disposed at a point (0, 0) in the plane P, a relation between the beam and the effective pupil region is a relation illustrated in FIG. 21. In FIG. 21, an arrow of a bold line represents a emission direction of a light beam emitted from the element lens. In FIG. 21, A represents the distance between the center of the eyeball and the center of the element lens, θ represents the angle between the light beam emitted from the element lens and the optical axis of the element lens, and α represents the angle between a straight line connecting the center of the eyeball and the center coordinates of the element lens and an z axis (axis passing the center of the MLA 2 and vertical to the MLA 2). A condition that the beam passes through the effective pupil region is represented by Expression (12) below.

$${A}^{2} {sin}^{2} ( α - θ ) < {R}^{2} \\ where \\ α = {tan}^{- 1} ( \frac{{y}_{m}}{{x}_{m}} ) , {A}^{2} = {x}_{m}^{2} + {y}_{m}^{2} \qquad ( 12 )$$

Thus, the beam is determined to be effective when the angle θ between the light beam emitted from the element lens and the optical axis of the element lens satisfies the condition represented by Expression (12). A correspondence relation between the point (x, y) on the plane D and the center coordinates (xm, ym) of the element lens is not limited to a particular relation. Thus, the effectiveness determination is preferably performed for the center coordinates (xm, ym) of each of a plurality of element lenses. This method can determine, irrespective of the plane P, whether the beam incident on the pupil is effective, based on a direction to which the pupil of the viewer points. This allows the viewer to observe the peripheral part of the virtual image with no vignetting present therein.

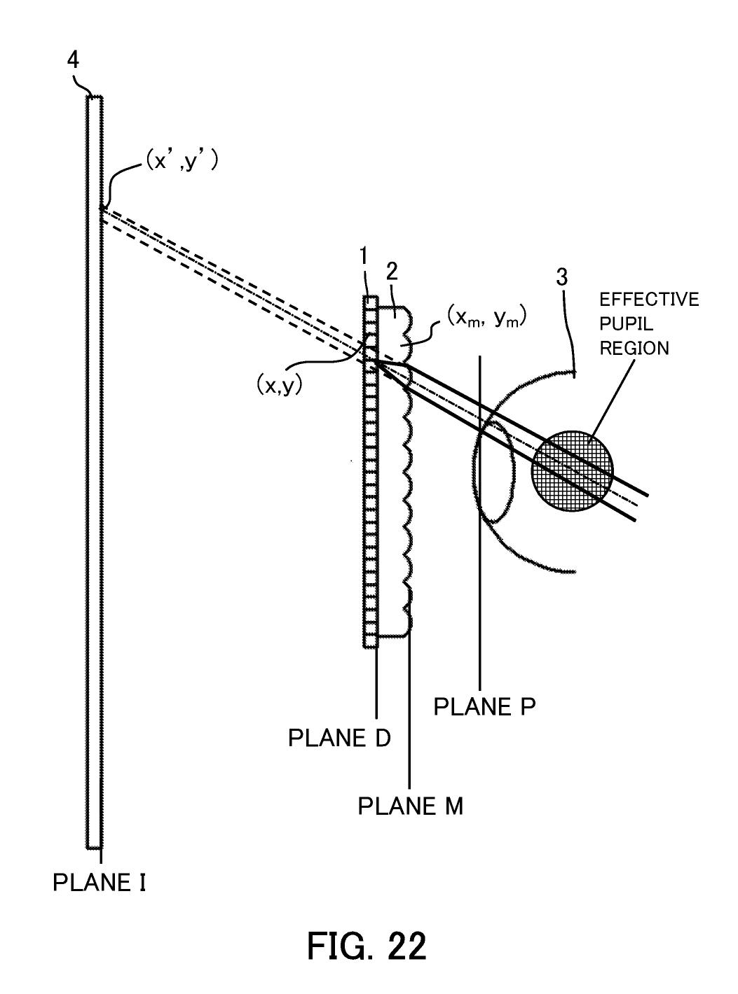

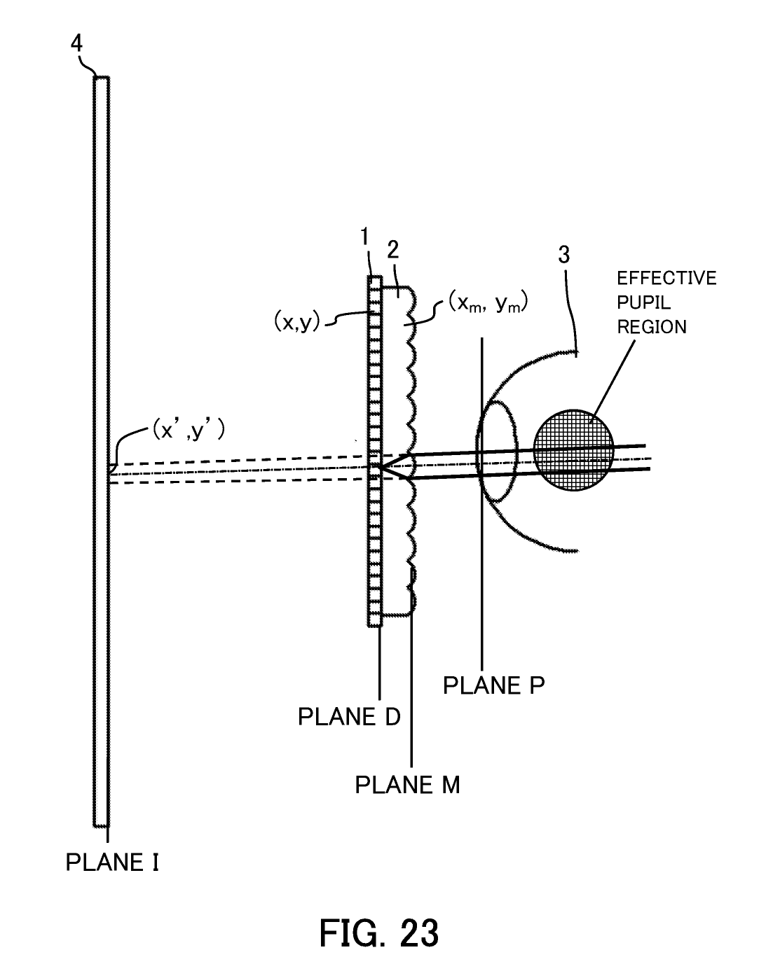

However, with this method, the central part and peripheral part of the virtual image cannot be simultaneously observed. FIGS. 22 and 23 are explanatory diagrams in an abnormal observation and a normal observation, respectively. FIG. 22 illustrates that the eyeball of the viewer points in a direction toward the center of the virtual image in the same situation as in FIG. 20 that beams for generating the virtual image are emitted. In this situation, no beams for generating the peripheral part of the virtual image are incident on the pupil of the viewer. However, as illustrated in FIG. 23, for a beam emitted from an element lens in a central part of the MLA 2, a beam passing through both a central part of the eyeball and the pupil is determined to be effective by the above-described effectiveness determination algorithm. Thus, when the eyeball of the viewer points in a direction toward the central part of the virtual image, the central part of the virtual image can be observed without any problem. In other words, the method according to the present embodiment allows constant observation of the virtual image in a central field of view in the direction to which the eyeball points, but has difficulties in observation of the virtual image in a peripheral field of view.

### Fifth Embodiment

Next, an image display apparatus according to a fifth embodiment of the present invention will be described. According to the fourth embodiment, the virtual image can be observed in the central field of view in the direction to which the eyeball points, but cannot be observed in the peripheral field of view. To solve this problem, the image display apparatus according to the present embodiment includes a mechanism (detection unit) of detecting an eyeball rotation, and an image processing unit (image processing unit) that generates a display image depending on a detected value by the detection mechanism. The mechanism of detecting the eyeball rotation is achieved by a technique disclosed in, for example, Kenji SUZUKI, “Development of Sight Line Input Method by Auto-focus Camera”, Optics, Vol. 23, pp. 25 and 26 (1994).

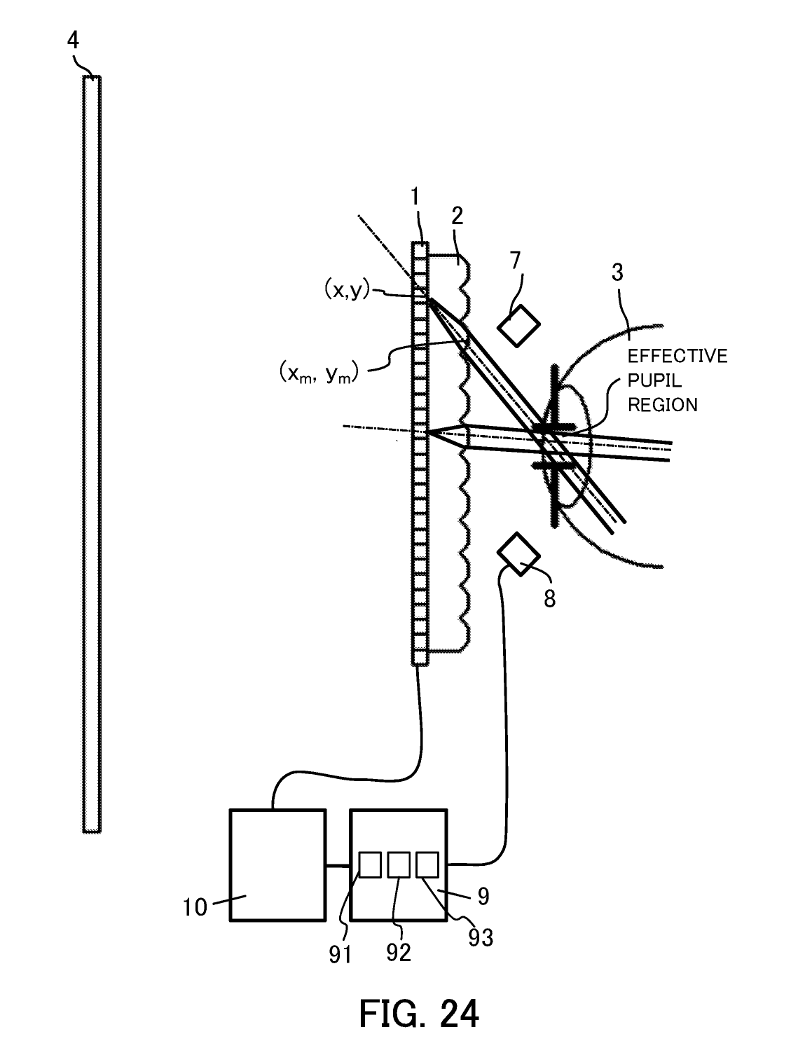

FIG. 24 is a configuration diagram of the image display apparatus in the present embodiment. In FIG. 24, reference numeral 7 denotes an illumination unit that illuminates the eye 3 (eyeball) of the viewer. The illumination unit 7 typically includes an infrared LED for illumination. Reference numeral 8 denotes an image pickup unit that picks up an image of a luminance distribution on the surface of the eye 3 (eyeball) illuminated by the illumination unit 7. Luminance distribution data picked up by the image pickup unit 8 is sent to an image processing unit 9. The image processing unit 9 includes a detection unit 91, an image processing unit 92, and a setting unit 93. The detection unit 91 detects (calculates) the position of the pupil of the viewer by image analysis. The image processing unit 92 generates image data based on the position of the pupil. More specifically, the setting unit 93 sets the effective pupil region depending on the detected position of the pupil (so as to make the effective pupil region substantially coincide with the position of the pupil). Then, the image processing unit 92 adjusts the luminance distribution of light based on the position of the effective pupil region.

In this manner, using the algorithm as described in the third embodiment, the image processing unit 9 calculates a combination of a pixel (x, y) and a virtual image point (x′, y′) for generating an effective beam. The image processing unit 9 also generates in real time an image (image data) to be displayed on the display 1 based on a relation between the pixel (x, y) and the virtual image point (x′, y′), and sends the image data to an image outputting portion 10 (image outputting unit). The image outputting portion 10 displays a desired image on the display 1 based on the image data.

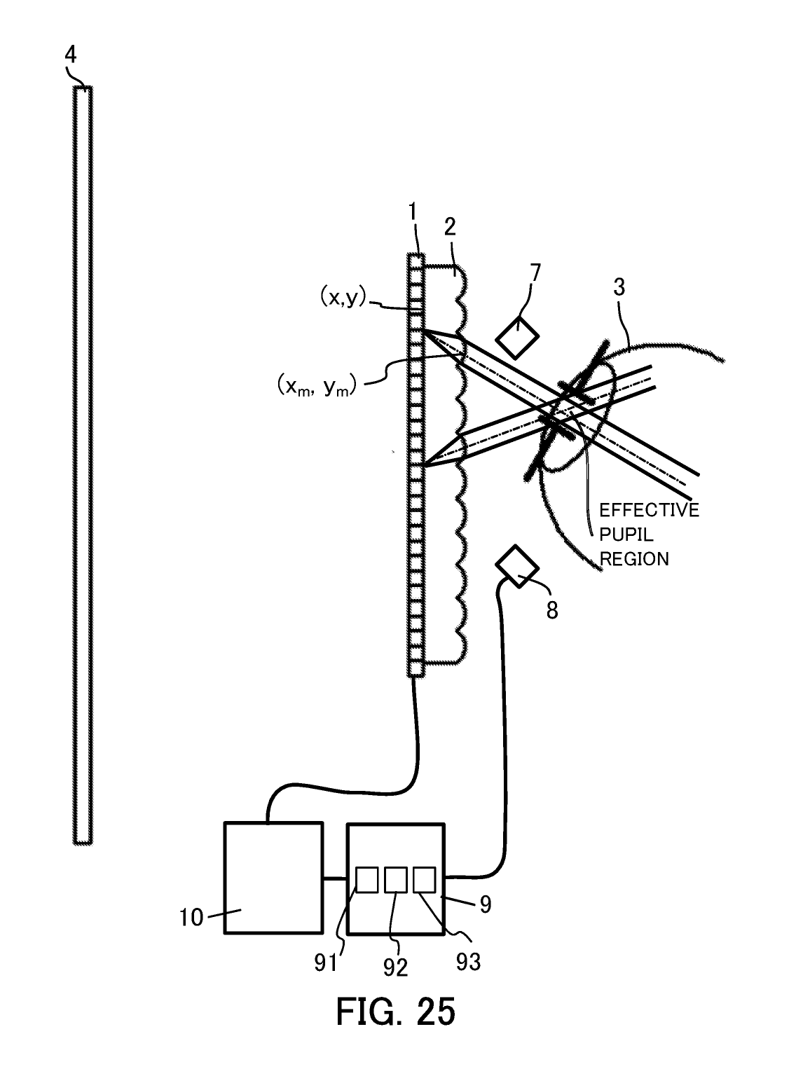

FIG. 24 illustrates a relation between the pupil and the effective beam in a case in which the eye 3 (eyeball) of the viewer points to the central part of the MLA 2. In this case, the eye 3 receives image generation beams for a central part of the virtual image, which is observed by the viewer through central vision, and a high view angle part of the virtual image observed through peripheral vision. Thus, the viewer can observe the whole of the virtual image with no vignetting. On the other hand, FIG. 25 illustrates a relation between the pupil and the effective beam in a case in which the eyeball of the viewer points to the peripheral part of the MLA 2. In this case, the eye 3 receives image generation beams for the high view angle part of the virtual image observed by the viewer through central vision, and the central part of the virtual image observed through peripheral vision. Thus, the viewer can observe the whole of the virtual image with no vignetting. In this manner, the present embodiment enables an appropriate image display depending on the rotation of the eyeball of the viewer. This allows observation of the whole of the virtual image with no vignetting.

In each of the embodiments, the image modulation unit (display 1) modulates a plurality of light beams so that a plurality of colliminated light beams coincide with light beams (simulated light beams) incident on points inside the pupil from the virtual pixels (virtual light source array) provided on a virtual image plane. In other words, the position of the virtual light source array coincides with the position of one of a plurality of planes including intersection points at which oppositely extended lines to the central traveling directions of the collimated light beams intersect with each other. Alternatively, the focal position of the collimated light beams coincides with the position of the virtual light source array. What is meant by the wording “coincide” includes not only a case of “precisely coincide” but also a case of “essentially coincide (substantially coincide)”. More specifically, the degree of “substantially coincide” corresponds to a range in which Expression (9) holds.

The lens unit (the MLA 2) is preferably a collimated optical system array including collimating optical systems. The collimated optical system array is disposed at a position closer than the distance of distinct vision from the pupil of the viewer. The virtual light source array is a light source array virtually disposed at a position further away from the distance of distinct vision from the pupil of the viewer. The collimated optical system array is more preferably disposed at a position closer than 15 diopter in the diopter scale from the pupil of the viewer.

According to each of the embodiments, the position of a virtual image to be displayed can be previously and accurately obtained, and image data can be generated based on information of the position. This achieves a high operation efficiency and generates no flaw in an observed virtual image. The resolution of the virtual image to be displayed can be previously and accurately obtained, and image data optimized in accordance with information of the resolution can be prepared. This achieves a high operation efficiency and can reduce image quality degradation of an observed virtual image.

In addition, the generation of a double image due to the sidelobe of the micro lens array can be reduced. Distortion and imaging shift of a virtual image due to optical aberration of the micro lens array can be compensated to achieve a favorable imaging state. A favorable virtual image with no light beam vignetting can be displayed by performing the beam effectiveness determination in accordance with the rotation of the eyeball of the viewer when a high view angle part of the virtual image is observed. The whole of the virtual image can be constantly observed with no light beam vignetting, irrespective of a direction to which the eyeball of the viewer points, by detecting the rotation of the eyeball of the viewer and generating image data based on a result of the detection. Each of the embodiments can be effectively applied to an optical apparatus that allows observation of the virtual image, in particular, to an image display apparatus mounted on the head of the viewer and used for observation of an enlarged virtual image.

Each of the embodiments can provide a small image display apparatus and a small image display system that are capable of appropriately displaying a virtual image without using an ocular optical system.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

### INDUSTRIAL APPLICABILITY

A small image display apparatus and a small image display system that are capable of appropriately displaying a virtual image without using an ocular optical system can be provided.

### REFERENCE SIGNS LIST

1 display (image modulation unit)
2 MLA (lens unit)

1-18. (canceled)

19. An image display apparatus comprising:
an image modulation unit including a plurality of pixels and capable of independently modulating a plurality of light beams emitted from the pixels; and
a lens unit configured to convert the light beams emitted from the pixels into a plurality of collimated light beams that intersect with one another at points in a pupil of a viewer,
wherein the image modulation unit modulates the light beams so that the collimated light beams coincide with light beams incident on the points in the pupil from virtual pixels provided on a virtual image plane, and
wherein a position of the virtual pixels coincide with a position of one of a plurality of planes including an intersection point at which oppositely extended lines to central traveling directions of the collimated light beams intersect with one another.

20. The image display apparatus according to claim 19, wherein a focal position of the collimated light beams coincide with the position of the virtual pixels.

21. The image display apparatus according to claim 19, wherein:
the points in the pupil are a plurality of light beam focusing points at which the collimated light beams intersect with one another, and
an expression below holds:
$$\frac{N}{N + 1} \cdot \frac{Δ c}{Δ p} ze < zb < \frac{N}{N - 1} \cdot \frac{Δ c}{Δ p} ze$$
where zb represents an optical distance between a principal plane of the lens unit and the virtual pixels, ze represents an optical distance between the principal plane of the lens unit and the light beam focusing point, Δc represents a pitch of a plurality of intersection points at which the oppositely extended lines of the collimated light beams intersect with one another, Δp represents an optical distance between the light beam focusing points adjacent to each other, and N represents the number of the light beam focusing points.

22. The image display apparatus according to claim 19, wherein:
the lens unit is a collimated optical system array including collimating optical systems,
the collimated optical system array is disposed at a position closer than a distance of distinct vision from the pupil of the viewer, and
the virtual pixels are a light source array virtually disposed at a position further away from the distance of distinct vision from the pupil of the viewer.

23. The image display apparatus according to claim 22, wherein the collimated optical system array is disposed at a position closer than 15 diopter in a diopter scale from the pupil of the viewer.

24. The image display apparatus according to claim 19, wherein a pitch of a plurality of light sources included in the virtual pixels coincides with a pitch of a plurality of intersection points of the oppositely extended lines of the collimated light beams.

25. The image display apparatus according to claim 19, wherein the lens unit includes a light shielding member that shields light.

26. The image display apparatus according to claim 19, wherein:
the points in the pupil are a plurality of light beam focusing points at which the collimated light beams intersect with one another, and
an expression below holds:
$$\frac{ze}{Δ p} = \frac{zm}{Δ d}$$
$$\frac{zm + ze}{N Δ d} = \frac{ze}{Δ l}$$
where ze represents an optical distance between a principal plane of the lens unit and the light beam focusing points, zm represents an optical distance between the principal plane of the lens unit and the image modulation unit, Δp represents an optical distance between the light beam focusing points adjacent to each other, Δl represents a lens pitch of the lens unit, Δd represents a pixel pitch of the image modulation unit, and N represents the number of the light beam focusing points.

27. The image display apparatus according to claim 26, wherein an expression below holds:
$$za = \frac{m Δ l}{m Δ l - n Δ p} ze$$
where za represents an optical distance between the principal plane of the lens unit and one of a plurality of planes each including a plurality of intersection points at which the oppositely extended lines of the collimated light beams intersect with one another, and m and n represent natural numbers.

28. The image display apparatus according to claim 26, wherein an expression below holds:
$$Δ c = \frac{μΔ l Δ p}{m Δ l - n Δ p}$$
where Δc represents a pitch of a plurality of intersection points at which the oppositely extended lines of the collimated light beams intersect with one another, m and n represent natural numbers, and μ represents a greatest common factor of the natural numbers m and n.

29. The image display apparatus according to claim 19, further comprising:
a light source of the virtual pixels;
the lens unit; and
a control unit configured to perform a reverse light beam trace only for a light beam passing through an effective pupil region of the viewer,
wherein the control unit provides a luminance for emitting light to a pixel disposed at a position at which the light beam and the image modulation unit intersect with each other.

30. The image display apparatus according to claim 29, further comprising a storage unit configured to previously store a result of the reverse light beam trace as data conversion table, wherein the control unit refers to the data conversion table when causing the image modulation unit to modulate the light beams.

31. The image display apparatus according to claim 29, wherein the effective pupil region is set as a region inside a circle centering about a center of the pupil on a surface identical to a surface of the pupil of the viewer.

32. The image display apparatus according to claim 29, wherein the effective pupil region is set as a region inside a sphere centering about a rotation center of an eyeball of the viewer.

33. The image display apparatus according to claim 19, further comprising:
a detection unit configured to detect a position of the pupil of the viewer; and
an image processing unit configured to generate image data based on the position of the pupil detected by the detection unit.

34. The image display apparatus according to claim 33, further comprising a setting unit configured to set a position of an effective pupil region depending on the position of the pupil detected by the detection unit, wherein the image processing unit adjusts a luminance distribution of light based on the position of the effective pupil region.

35. An image display system comprising:
the image display apparatus; and
an image information supply apparatus configured to supply image information to the image display apparatus,
wherein the image display apparatus comprises:
an image modulation unit including a plurality of pixels and capable of independently modulating a plurality of light beams emitted from the pixels; and
a lens unit configured to convert the light beams emitted from the pixels into a plurality of collimated light beams that intersect with one another at points in a pupil of a viewer,
wherein the image modulation unit modulates the light beams so that the collimated light beams coincide with light beams incident on the points in the pupil from virtual pixels provided on a virtual image plane, and
wherein a position of the virtual pixels coincide with a position of one of a plurality of planes including an intersection point at which oppositely extended lines to central traveling directions of the collimated light beams intersect with one another.
